(19) United States
(12) Patent Application Publication
(10) Pub. No.: US 2005/0123182 A1
(43) Pub. Date: Jun. 9, 2005

(54) Temperature sensor

(75) Inventors: Thomas Sheng, Hsinchu (TW); Yung-Chuan Wu, Hsinchu (TW)

Correspondence Address: TROXELL LAW OFFICE PLLC;SUITE 1404, 5205 LEESBURG PIKE, FALLS CHURCH, VA, 22041, US

(73) Assignee: Avision Inc.

(21) Appl. No.: 11/000,050

(22) Filed: Dec. 1, 2004

(30) Foreign Application Priority Data
Dec. 3, 2003 (TW) 092134102

(51) Int. Cl. G06K 9/00

(52) U.S. Cl. 382/128; 250/339.04

(57) ABSTRACT

This invention provides a temperature sensor to sense a temperature profile of a target surfaces and to judge whether the high-temperature area, having a temperature higher than a predetermined temperature, of the target surface is a major area. The temperature sensor comprises an image capturing module, an image processing module, an image database and a comparison module. The image capturing module is used to measure the temperature profile of the target surface and capture a heat image of the target object. The image processing module is used to label the high-temperature area wherein the temperature is high than a predetermined temperature. The image database stores a plurality of images of the major areas. The comparison module compares an image of the high-temperature area with the image of the major area stored in an image database and decides whether the high-temperature area is the major area.

### BACKGROUND OF THE INVENTION

1. Field of the Invention

This present invention relates to a temperature sensor, especially to a temperature sensor for automatically sensing a temperature profile of a target surface and for judging whether a high-temperature area, having a temperature higher than a predetermined temperature, of the target surface is a major area.

2. Description of the Prior Art

There are many different kinds of temperature sensors of the prior art for sensing body temperature, such as different kinds of mercury thermometers, heat-sensitive resistor thermometers, liquid crystal thermometers, infrared thermometers . . . etc. The most convenient kind to use is an infrared thermometer which senses a temperature profile without touching a target surface. Depending on functions of different infrared thermometers, a local or a whole temperature profile of the target surface can be detected in a few seconds and only in a distance of several centimeters or meters.

An infrared temperature sensor of the prior art utilizes the property of an infrared ray to sense temperature without directly touching a whole or a local part of the human body, and it switches the temperature profile into an electric signal which is transmitted to a display module, then the display module shows the temperature profile in gray or colorful shades. This kind of infrared temperature sensor can be conveniently applied in places with heavy people-circulation and rapid motion, such as in airports, schools, department stores, shopping centers, or hospitals. At these places infrared temperature sensors are used to detect human temperature.

An infrared temperature sensor of the prior art displays the sensing result in an image form on the display module; however, a trained person is needed to judge whether a high-temperature area of a person's exteriority is higher than a predetermined temperature, or that person has what is called a “fever”. As factors like environment, types of clothing, and all kinds of personal accessories often influence the obtained result, it makes the situation complicated and difficult for the trained person to judge whether a person has a fever, thus diminishing the efficiency of the infrared sensor and the accuracy of the judgments made. For example, in a situation that a person just basking in the sun outdoors is sensed by an infrared temperature sensor, the infrared temperature sensor would show that the temperature of the person's hair to be higher than a normal state and mislead spectators to conclude that the person has a fever, whereas the person's hair simply absorbs too much radiation of sunlight. In addition, to judge whether the high-temperature area of the person's exteriority is higher than a predetermined temperature from the data shown on the display module needs an experienced person to make a decision, so the costs of labor will be increased. Thus, it is necessary to provide a temperature sensor for automatically sensing in order to reduce the costs of labor and optimize the efficiency.

### SUMMARY OF THE INVENTION

One objective of the present invention is to provide a temperature sensor for sensing a temperature profile of a target surface and to judge whether a high-temperature area, having a temperature higher than a predetermined temperature, of the target surface is a major area. Another objective of the present invention is to provide a temperature sensor for automatically judging whether the high-temperature area, having a temperature higher than a predetermined temperature, of the target surface is a major area, in order to optimize monitoring efficiency and reduce the costs of labor.

The present invention provides a temperature sensor for sensing a temperature profile of a target surface and judges whether a high-temperature area, having a temperature higher than a predetermined temperature, of the target surface is a major area. The temperature sensor comprises an image capturing module, an image processing module, an image database, and a comparison module. An image capturing module is used for measuring the temperature profile of the target surface and for capturing a beat image of the target surface. An image processing module is used for filtering the heat image of the target surface according to the temperature profile and labelling the high-temperature area. An image database is used for storing plural images of the major areas. A comparison module, based on a figure recognition technology, is used for comparing an image of the high-temperature area with the image of the major area stored in the image database and for deciding whether the high-temperature area is the major areas.

The temperature sensing method of the present invention can automatically determine whether a high-temperature area, having a temperature higher than a predetermined temperature, of the target surface is a major area, with no trained persons to make the judgment; thus, the present invention can speed up the monitoring process and reduce the costs of labor. Moreover, the temperature sensing method of the present invention compares only the images of major areas, so that factors like environment, types of clothing and all kinds of personal accessories tending to influence judgment can be averted.

The advantage and spirit of the invention may be understood by the following recitations together with the appended drawings.

### BRIEF DESCRIPTION OF THE APPENDED DRAWINGS

FIG. 1 is a schematic diagram of the temperature sensor of the present invention.

FIG. 2 is a schematic diagram utilizing the temperature sensor in FIG. 1 for sensing the temperature profile of the target surface.

FIG. 3A is a schematic diagram of a first image of the major area stored in the image database as illustrated in FIG. 1

FIG. 3B is a schematic diagram of a second image of the major area stored in the image database as illustrated in FIG. 1.

FIG. 4 is a block diagram of another embodiment of the temperature sensor of the present invention

FIG. 5 is a flowchart of the temperature sensing method of the present invention.

### DETAILED DESCRIPTION OF THE INVENTION

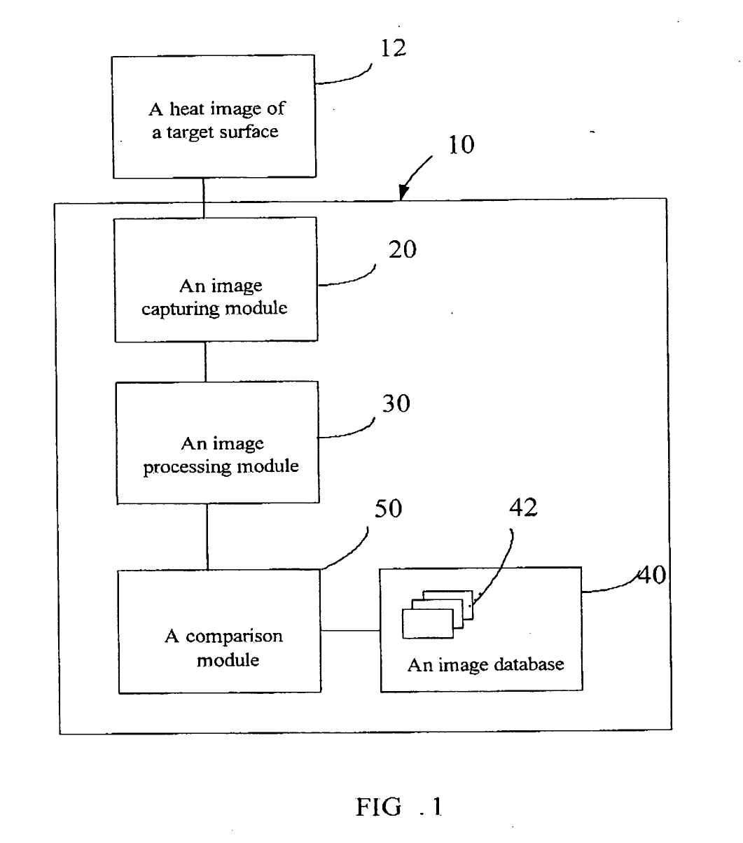

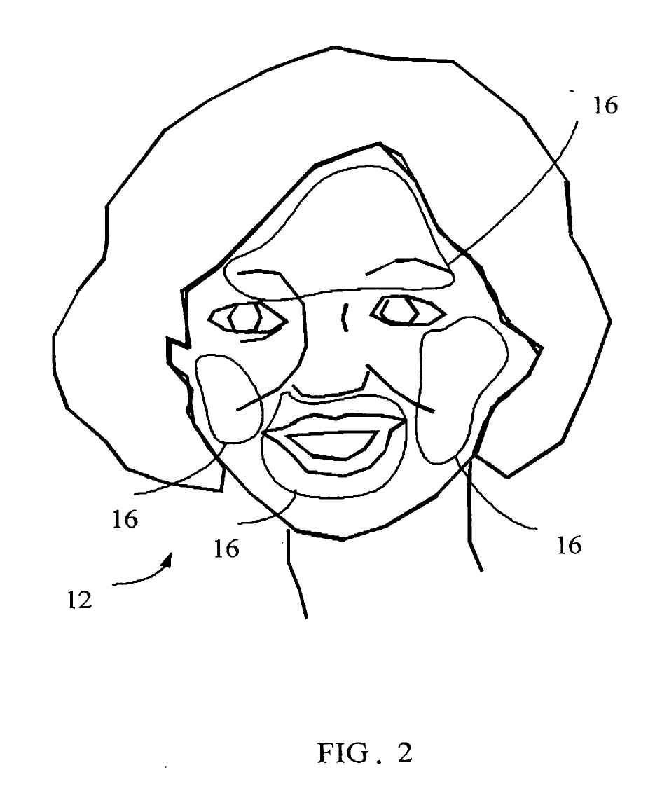

Referring to FIG. 1 and FIG. 2, FIG. 1 is a schematic diagram of the temperature sensor 10 of the present invention, and FIG. 2 is a schematic diagram utilizing the temperature sensor 10 in FIG. 1 for sensing the temperature profile of the target surface. The temperature sensor 10 of the present invention comprises an image capturing module 20, an image processing module 30, an image database 40, and a comparison module 50. The temperature sensor 10 senses a temperature profile of a target surface and judges whether a high-temperature area, having a temperature higher than a predetermined temperature, of the target surface is a major area. In this embodiment, the target surface is a person's head; please refer to FIG. 1 and FIG. 2. An image capturing module 20 measures the temperature profile of the target surface and captures a heat image of the target surface with infrared image sensing technology. In the embodiment as illustrated in FIG. 2, the heat image 12 is a woman's head. The heat image 12 is composed of a plurality of pixels, wherein each pixel can be displayed in a color corresponding to the temperature at each location of the target surface.

An image processing module 30 filters the heat image 12 of the target surface according to the temperature profile and labels the high-temperature area. For example, the high-temperature area, which has a temperature higher than a predetermined temperature, of the temperature profile is labeled with various colors.

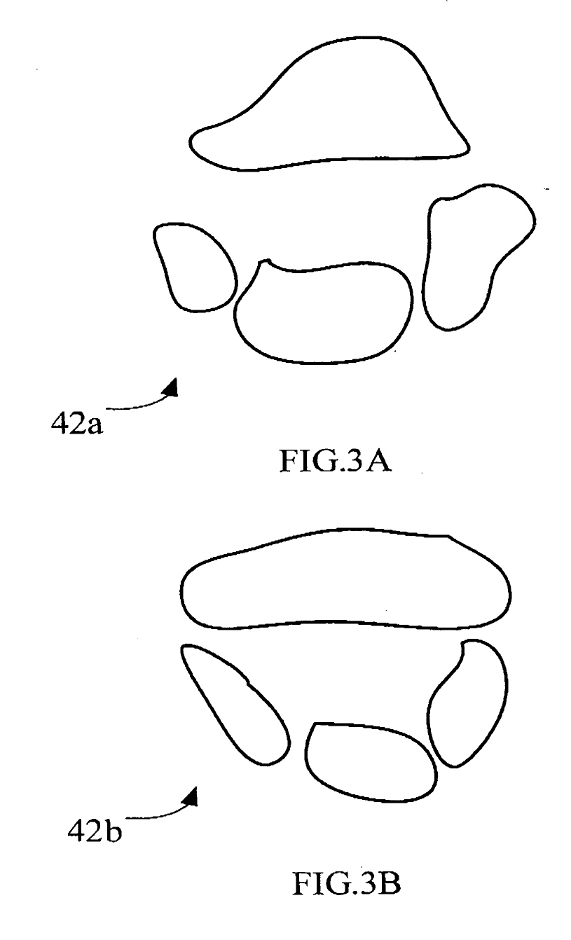

Referring to FIG. 3A and FIG. 3B, FIG. 3A is a schematic diagram of a first image of the major area 42a stored in the image database 40 as illustrated in FIG. 1, and FIG. 3B is a schematic diagram of a second image of the major area 42b stored in the image database 40 as illustrated in. FIG. 1. The image database 40 stores the images of the major areas 42 (as illustrated in FIG. 1). In the embodiment as illustrated in FIG. 2, the major areas 16 represents real surface areas of a human body including a forehead, two cheeks, temples, and the areas in the vicinity of the mouth where a high temperature would indicate that the person might have a fever. The first image 42a and the second image 42b respectively illustrate images of different major areas 16 stored in the image database 40.

The comparison module 50, based on a figure recognition technology, compares the images of the high-temperature areas of the target surface with the images of the major areas 42 stored in the image database 40, and it then decides whether the high-temperature area of the target surface is the major area 16. The comparison module 50 compares each pixel of the image of the high-temperature area with each pixel of the image of the major areas 42, wherein, the image processing 30 has already filtered the heat images 12 of the target surface according to the temperature profile and has labelled the high-temperature area, of which the temperature is higher than a predetermined temperature, with various colors, in the embodiment as illustrated in FIG. 2, a matching value is obtained after the comparison module 50 evaluates the similarity between a pixel of the image of the high-temperature area and a pixel of the image of the major areas 42a, where the matching value is a quantitative measurement of the similarity between the two pixels in, for instance, colors, gray scale or other characteristics of pixels. When the sum of the matching values exceeds a critical value, the high-temperature area is judged as the major area 16. As illustrated in FIG. 3A and FIG. 3B, the image database 40 records many different images of the major areas 42, wherein the major areas 16 vary with different types of human body features such as long hair, short hair, bald, and hat-wearing.

Thus, when a place with heavy people-circulation and rapid motion, such as airports, schools, department stores, shopping centers or hospitals, makes use of the temperature sensor 10 of the present invention to sense human temperature, the temperature sensor 10 can automatically judge whether the high-temperature area of the target surface is higher than a predetermined temperature, so that not only the accuracy of the judgment is improved, but also the monitoring efficiency. Furthermore, the present invention doesn't require a trained person to compare or monitor the sensing result to decide whether the high-temperature area of the target surface is higher than a normal state, such that it speeds up the entire process and reduces the costs of labor.

Besides, the temperature sensor 10 of the present invention judges by comparing the images of the major area 16, hence erroneous judgment can be prevented. For example, in a situation of the prior art where a person walks indoors from outside wearing a hat in a dark color, because the hat has absorbed too much heat of sunlight, the raise in the temperature of the hat may lead to the erroneous judgment that the person's body temperature is higher than a predetermined temperature. The present invention, however, judges by comparing the temperatures of the major areas 16, so as to prevent erroneous judgment that may be caused by factors like environment, clothing types and all kinds of personnel accessories.

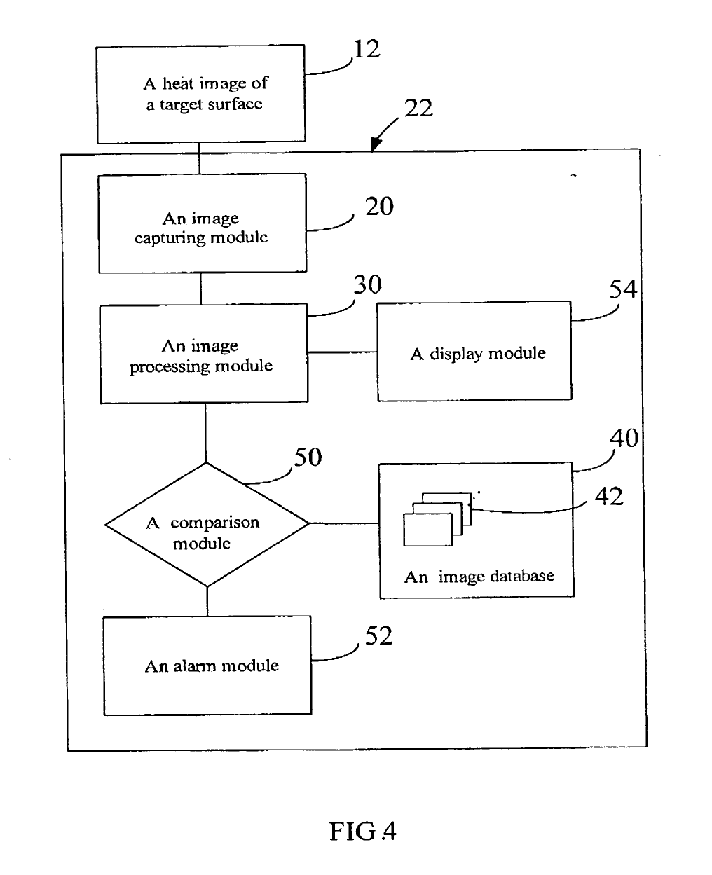

Referring to FIG. 4, FIG. 4 is a block diagram of another embodiment of the temperature sensor 22 of the present invention. The difference between the temperature sensor 22 and the temperature sensor 10 illustrated in FIG. 1, lies in that the temperature sensor 22 further comprises an alarm module 52, and a display module 54.

The alarm module 52 sends out an alarm signaling that the high-temperature area is the major area when the comparison module 50 judges that the high-temperature area, having a temperature higher than a predetermined temperature, of the target surface is the major area. The display module 54 displays the images of the high-temperature areas.

Furthermore, the temperature sensor 22 of the present invention not only automatically judges whether the high-temperature area of the target surface is higher than a predetermined temperature but also automatically sends an alarm to signal that the temperature of major areas of the target surface is higher than a predetermined temperature.

Besides, in the temperature sensor 22, the temperature profile of the target surface is detected by the image capturing module 20 using microwave sensing technology. In the temperature sensor 22, the image processing module 30 filters the heat image 12 of the target surface according to the temperature profile, and labels the high-temperature area, wherein the images of the high-temperature area is retained and the rest of the images of the heat image 12 is discarded.

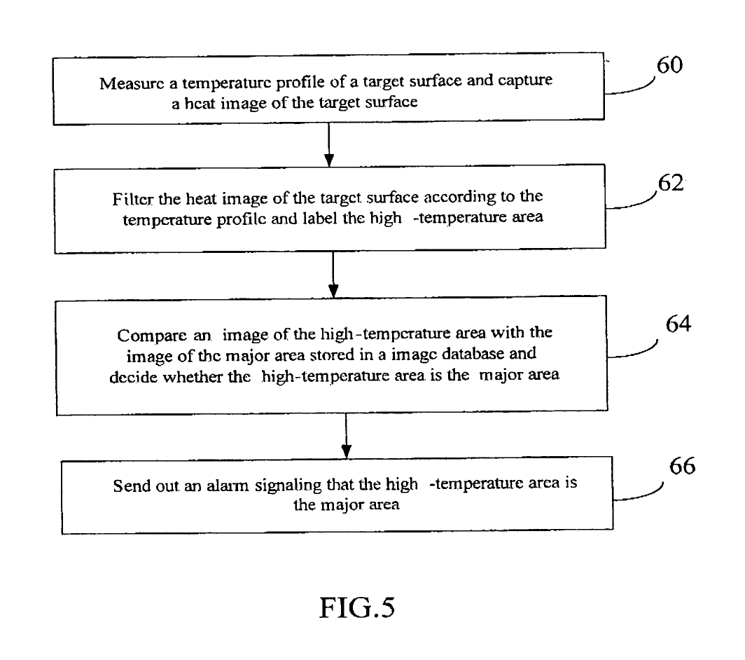

Referring to FIG. 5. FIG. 5 is a flowchart of the temperature sensing method of the present invention. Taking the temperature sensor 22 in FIG. 4 as an example, the temperature sensing method comprises the following steps:
S60: measuring the temperature profile of the target surface and capturing a heat image 12 of the target surface,
S62: filtering the heat image 12 of the target surface according to the temperature profile and labeling the high-temperature area,
S64: comparing the image of the high-temperature area with the image of the major area 42 stored in a image database 40 and deciding whether the high-temperature area is the major area 16.

The step of S62 further comprises the step of labeling only the parts of the heat image 12 with the temperature exceeding the predetermined temperature.

The step of S62 also comprises a step of displaying the images of the high-temperature areas on the display module 54.

After the step S64 is completed, the step of S66 to send out an alarm may be added to inform a trained person that the high-temperature area of the target surface is the major area 16.

Therefore, the temperature sensor of the present invention not only automatically judges whether the temperature of the high-temperature area of the target surface is higher than a predetermined temperature but also automatically sends out an alarm signaling that the high-temperature area is the major area, not requiring a trained person to make the judgment. Thus the temperature sensor of the present invention has a greater efficiency than that of the prior art and reduces the costs of labor. Furthermore, the temperature sensing method judges by comparing the temperatures of certain areas of concern, so as to prevent erroneous judgment that may be caused by factors like environment, clothing types, and all kinds of personal accessories.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A temperature sensor for sensing a temperature profile of a target surface and judging whether a high-temperature area, having a temperature higher than a predetermined temperature, of the target surface is a major area, the temperature sensor comprising:
an image capturing module for measuring the temperature profile of the target surface and for capturing a heat image of the target surface;
an image processing module for filtering the heat image of the target surface according to the temperature profile and labelling the high-temperature area;
an image database for storing a plurality of images of the major areas; and
a comparison module for comparing an image of the high-temperature area with the image of the major area stored in the image database and deciding whether the high-temperature area is the major areas.

2. The temperature sensor of claim 1, wherein the comparison module evaluates the similarity between a pixel of the image of the high-temperature area and a pixel of the image of the concerned areas, and obtains a matching value for each pair of the pixels and a sum of the matching values, where the matching value is a quantitative measurement of the similarity between the two pixels.

3. The temperature sensor of claim 2, wherein the sum of the matching values exceeds a critical value, indicating the high-temperature area is the major area.

4. The temperature sensor of claim 1, further comprising an alarm module, connected to the comparison module, for sending out an alarm signaling that the high-temperature area is the major area.

5. The temperature sensor of claim 1, further comprising a display module for displaying an image of the high-temperature area.

6. The temperature sensor of claim 1, wherein the temperature profile of the target surface is detected with an infrared image sensing technology.

7. The temperature sensor of claim 1, wherein the temperature profile of the target surface is detected with a microwave image sensing technology.

8. The temperature sensor of claim 1, wherein the image processing module labels the high-temperature area with various colors.

9. The temperature sensor of claim 1, wherein the image processing module retains the image of the high-temperature area and discards the rest of the heat image of the target surface.

10. A temperature sensing method for sensing a temperature profile of a target surface and judging whether a high-temperature area, having a temperature higher than a predetermined temperature, of the target surface is a major area, the temperature sensing method comprising:
measuring the temperature profile of the target surface and capturing a heat image of the target surface;
filtering the heat image of the target surface according to the temperature profile and labelling the high-temperature area; and
comparing an image of the high-temperature area with an image of the concerned area stored in a image database and deciding whether the high-temperature area is the major area.

11. The temperature sensing method of claim 10, further comprising a step of:
sending out an alarm signaling that the high-temperature area is the major area.

12. The temperature sensing method of claim 10, further comprising a step of:
displaying an image of the high-temperature area.

13. The temperature sensing method of claim 10, further comprising a step of:
evaluating the similarity between a pixel of the image of the high-temperature area and a pixel of the image of the concerned areas, and obtaining a matching value for each pair of the pixels and a sum of the matching values, where the matching value is a quantitative measurement of the similarity between the two pixels.

14. The temperature sensing method of claim 13, wherein the sum of the matching values exceeds a critical value, indicating the high-temperature area is the major area.

15. The temperature sensing method of claim 10, wherein the temperature profile of the target surface is detected with an infrared image sensing technology.

16. The temperature sensing method of claim 10, wherein the tcmperatuare profile of the target surface is detected with a microwave image sensing technology.

17. The temperature sensing method of claim 10, further comprising a step of
labelling the high-temperature area with various colors.

18. The temperature sensing method of claim 10, further comprising a step of:
retaining the image of the high-temperature area and discarding the rest of the heat image of the target surface.
